(19) United States
(12) Patent Application Publication
(10) Pub. No.: US 2003/0222143 A1
(43) Pub. Date: Dec. 4, 2003

(54) Precision laser scan head

(76) Inventor: Phillip V. Mitchell, Laguna Niguel, CA (US)

Correspondence Address: IRELL & MANELLA LLP, 840 NEWPORT CENTER DRIVE, SUITE 400, NEWPORT BEACH, CA, 92660, US

(21) Appl. No.: 10/163,136

(22) Filed: Jun. 4, 2002

(51) Int. Cl. G06K 7/10; G06K 7/14

(52) U.S. Cl. 235/454

(57) ABSTRACT

An optical beam scanner. The scanner includes a beam centering device that directs a light beam onto a beam scanning device. The beam centering device can compensate for positioning errors in the light beam. The scanning and centering device may each have feedback loops used to control the scanning and position of the beam, respectively.

### BACKGROUND OF THE INVENTION

1. Field of the Invention

The subject matter disclosed generally relates to the field of laser beam scanners.

2. Background Information

Manufacturing process equipment may contain a laser to perform work on a piece part. For example, laser micro-machining equipment utilize lasers to ablate material from the piece part. Such processes include the step(s) of scanning a laser beam across a piece part. The scanning process is performed by a laser scanner.

FIG. 1 shows a laser scanner 1 of the prior art. The scanner 1 redirects and moves a laser beam 2 along a linear path. The laser beam 1 is generated by a laser 3 and reflected by bending mirrors 4. The system 1 includes a first fast steering mirror (FSM) 5 that can be tilted to change the direction of the laser beam 1. The beam 1 is directed through a scanning lens 6 located at the output of the scanner 1.

The FSM 5 includes a mirror 7 that is tilted by one or more actuators 8. The actuators 8 are driven by a mirror controller 9. The controller 9 also receives position feedback information from a sensor (not shown) that measures the angular position of the mirror 7 relative to the fixed support structure. The controller 9 processes both the input commands and the feedback signals to generate output signals that drive the actuators 8, tilt the mirror 7 and scan the laser beam 2.

While the feedback signals and controller servo algorithms may insure that the mirror 7 is at the proper tilt angle, the system shown in FIG. 1 does not compensate for positioning errors separate from the tilt angle of the mirror 7. For example, the output beam angle from the laser 3 may change over time. The shift in the output angle will result in error in the position of the output beam even though the mirror 7 is at the proper orientation.

### BRIEF SUMMARY OF THE INVENTION

A light beam scanner that includes a beam centering device that positions a light beam onto a beam scanning device.

### BRIEF DESCRIPTION OF THE DRAWINGS

FIGS. 1 is a schematic of a beam scanner of the prior art;

FIG. 2 is a schematic of a beam scanner;

FIG. 3 is a schematic of an embodiment of the beam scanner;

FIG. 4 is a schematic of an alternate embodiment of the beam scanner;

FIG. 5 is a schematic of an alternate embodiment of the beam scanner;

FIG. 6 is a schematic of an alternate embodiment of the beam scanner.

### DETAILED DESCRIPTION

Disclosed is an optical beam scanner. The scanner includes a beam centering device that directs a light beam onto a beam scanning device. The beam centering device can compensate for positioning errors in the light beam. The scanning and centering devices may each have feedback loops used to control the scanning and positioning of the beam, respectively.

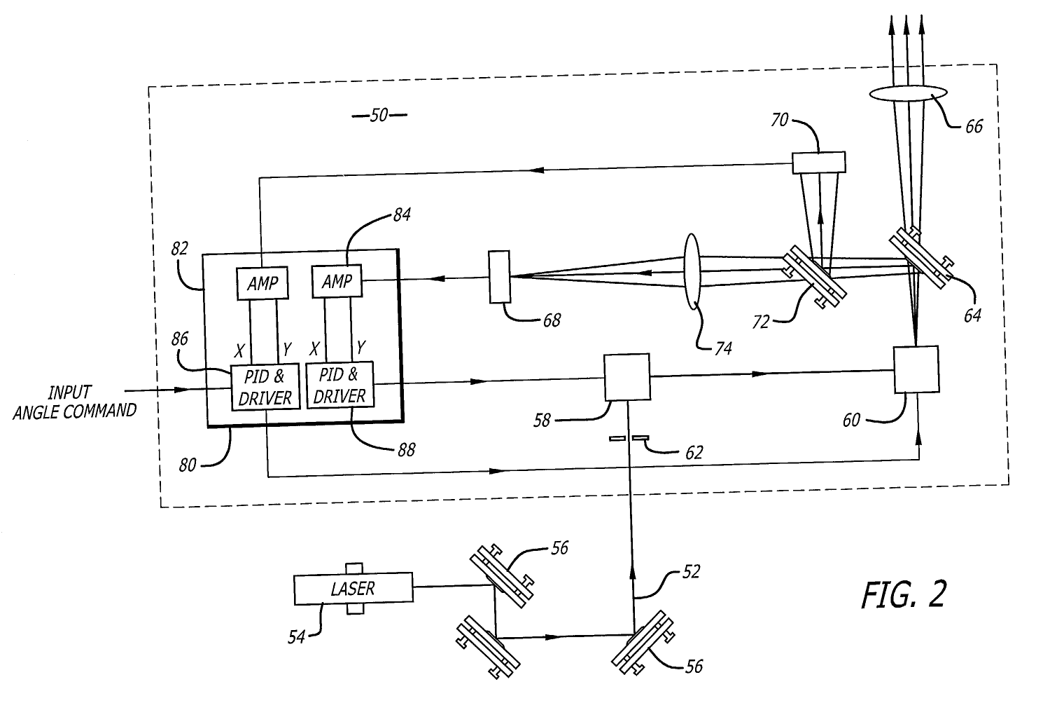

Referring to the drawings more particularly by reference numbers, FIG. 2 shows an optical beam scanner 50. The scanner 50 can stabilize and maintain a light beam 52 that is emitted from a light source 54. The beam 52 travels along an optical path. The light source 54 may be a laser that emits a laser beam. The beam 52 can be reflected by bending mirrors 56. The scanner 50 may be a separate assembly that is attached to the light source 54 and mirrors 56. For example, the scanner 50 may be attached to a laser machine.

The scanner 50 includes a beam centering device 58 and a beam scanning device 60. The beam centering device 58 directs the light beam 52 onto a desired location on the beam scanning device 60. For example, the device 60 may direct the light beam 52 onto the center of the beam scanning device 60. The beam scanning device 60 can redirect and angularly displace the beam 52 in a scanning manner. The beam 52 may enter the scanner 50 through an input aperture 62. The beam 52 may exit the scanner 50 through a beamsplitter 64 and a scanning lens 66.

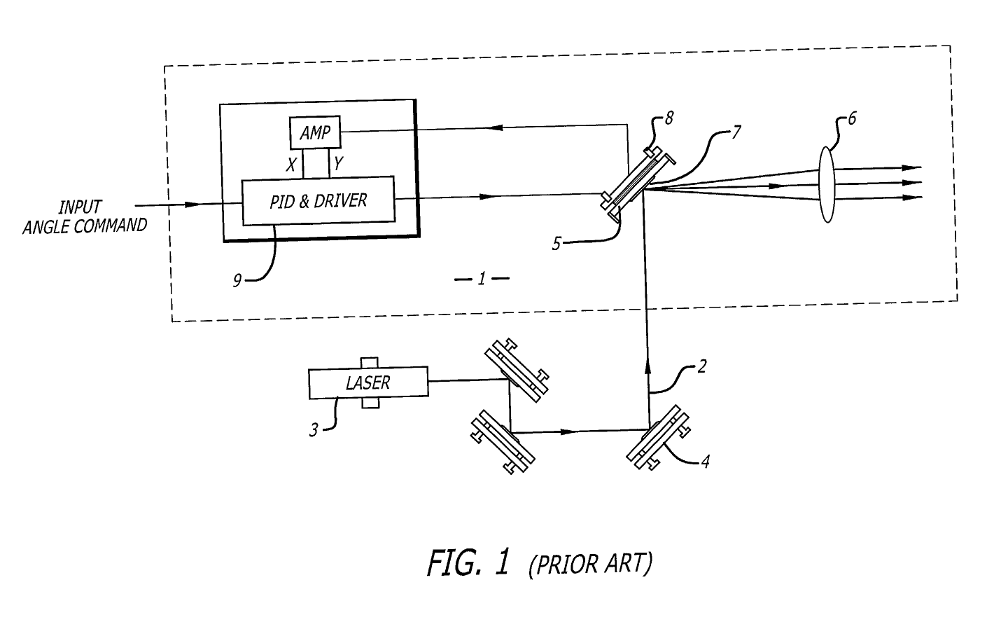

A portion of the light beam 52 may be directed onto photodetectors 68 and 70 by beamsplitter 64 and an additional beamsplitter 72. An imaging lens 74 may focus an image of the beam 52 onto photodetector 68. Photodetector 68 may be a quad cell device that can be used to determined whether the light beam is at the desired location at the beam scanning device 60. Photodetector 70 may be a lateral effect detector that is used to sense the actual position of the light beam being scanned by device 60. Sensing the position of the beam provides a more accurate feedback of the beam position downstream of the scanning device 60 than the mechanical feedback position of the scanning mirror found in optical scanners of the prior art (see FIG. 1).

The photodetectors 68 and 70 are connected to a controller 80. The controller 80 includes amplifiers 82 and 84 that amplify the output signals of the detectors 68 and 70. The controller 80 also contains error control and driver circuits 86 and 88 that provide output signals to the compensation devices 60 and 58, respectively. Circuit 86 also receives input angle commands from an external source.

Each circuit 86 and 88 may include hardware and software/firmware that performs known proportional-integral-derivative control processing. Circuit 86 may process a feedback signal from detector 70 with the input angle command to generate an output signal that causes the beam scanning device to change the output angle of the laser beam 52. Likewise, circuit 88 can process a feedback signal from detector 68 to generate an output signal that actuates the beam centering device 58 to direct the beam onto the center of the beam scanning device 60.

In operation, the light beam 52 is directed into the scanner 50 from the light source 54. The beam centering device 58 directs the light beam 52 onto the center of the beam scanning device 60. The detector and control circuit 88 insure that the beam 52 is maintained on the center of the scanning device 60. The downstream detection of the light beam position and the upstream correction of the beam compensates for drift and tilt errors in the system.

The control circuit 86 receives an input command to change the output angle of the light beam 52 and processes this command to generate an output signal to the beam scanning device 60. The beam scanning device 60 then changes the beam angle to create a linear scan by the beam 52. The detector 70 provides feedback information on the actual position of the beam 52 so that the circuit 86 can compensate for any deviation between the desired commanded position and the actual position.

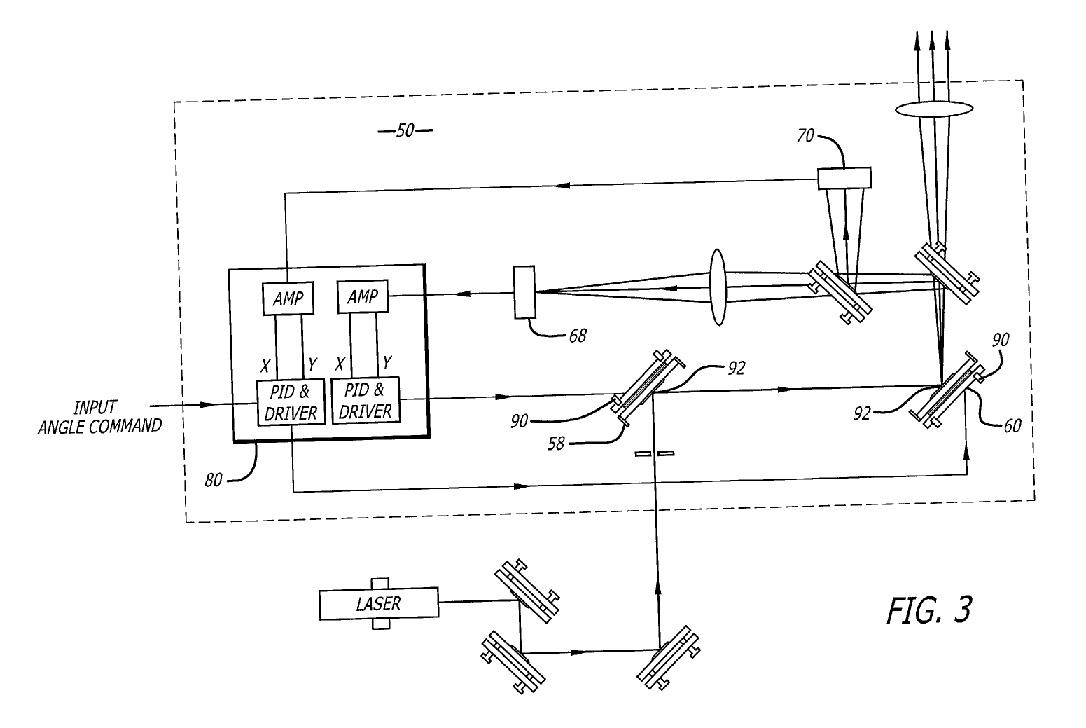

FIG. 3 shows an embodiment of the scanner 50 wherein the beam centering device 58 and the beam scanning device 60 are each fast steering mirrors (FSMs). Each FSM includes a plurality of actuators 90 that can tilt a reflective mirror 92. The actuators 90 are driven by circuits 86 and 88.

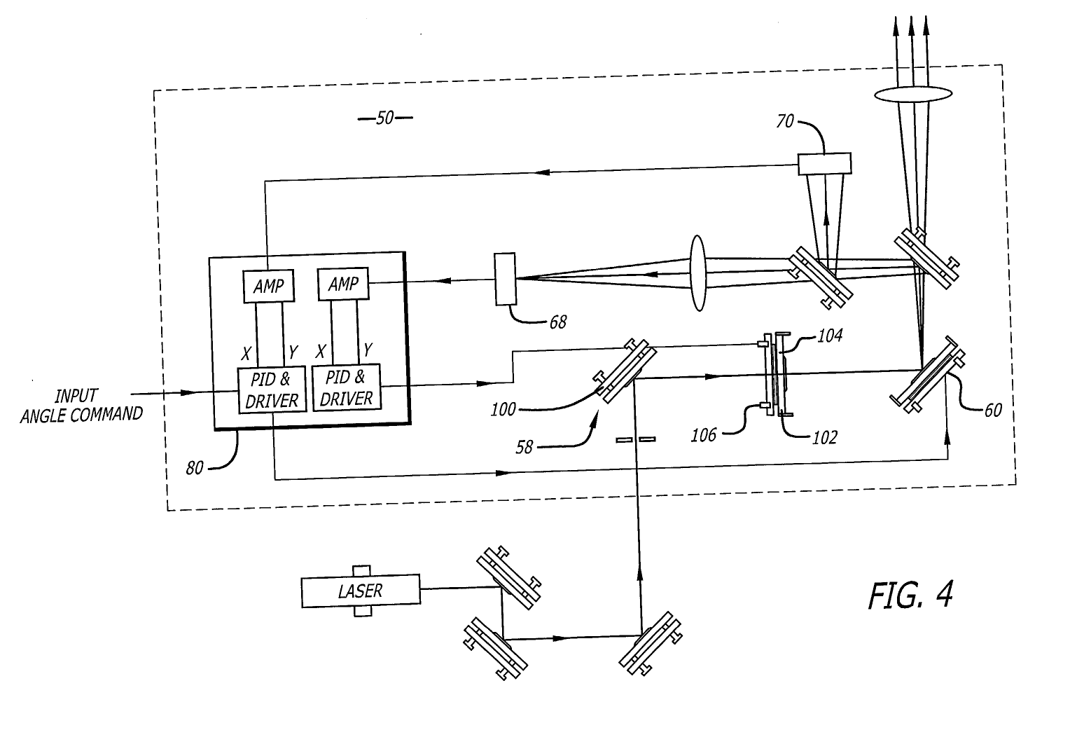

FIG. 4 shows an embodiment of the scanner 50 wherein the beam centering device 58 includes a fast steering mirror (FSM) 100 and a fast steering plate 102 (FSP). The FSP includes a transmissive plate 104 that is pivoted by actuators 106 driven by control circuit 86. The plate 106 uses refraction and varying impingement angles to vary the lateral position of the beam. This approach will minimize the tilt error that may be created by the single FSM for the embodiment shown in FIG. 3. This embodiment is preferable for monochromatic light beams. A light beam with multiple wavelengths may produce chromatic feedback errors.

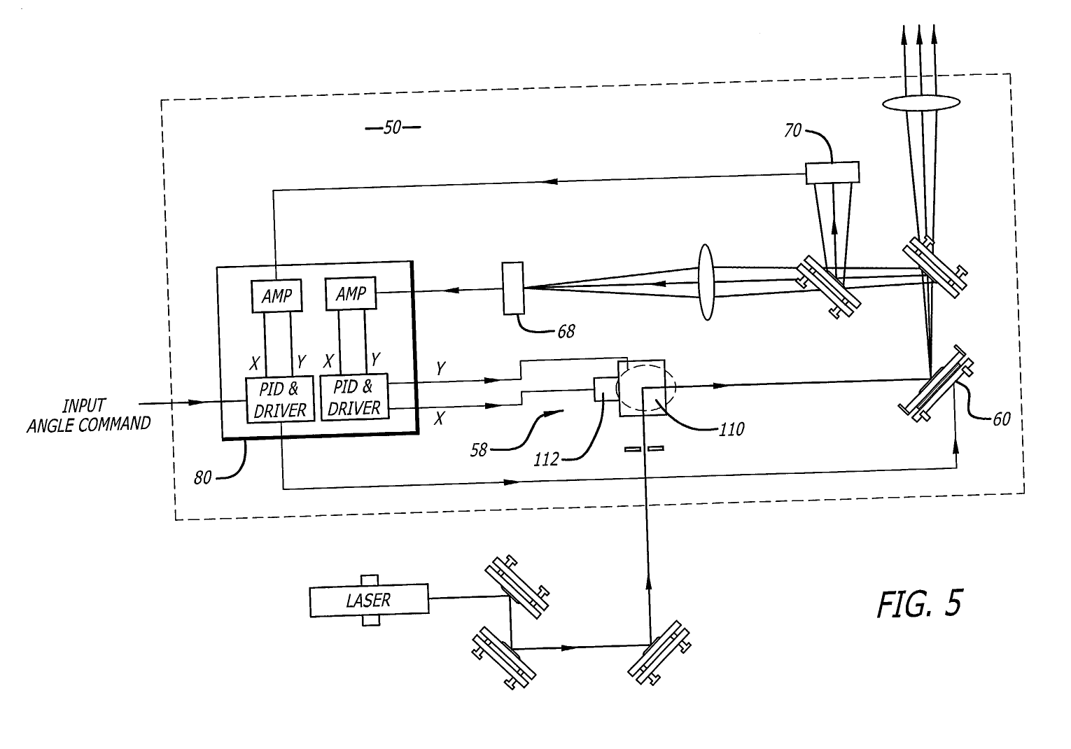

FIG. 5 shows another embodiment wherein the beam centering device 58 has a pair of reflective mirrors 110 that are each moved by a linear translator 112 (only one mirror and translator is shown). One mirror 110 may move the beam 52 along an x axis, the other mirror may move the beam 52 along an orthogonal y axis. Each mirror 110 may reflect the beam 52 in an orthogonal direction resulting in 90 degree turn from the input beam 52. The translators 112 may include voice coil motors.

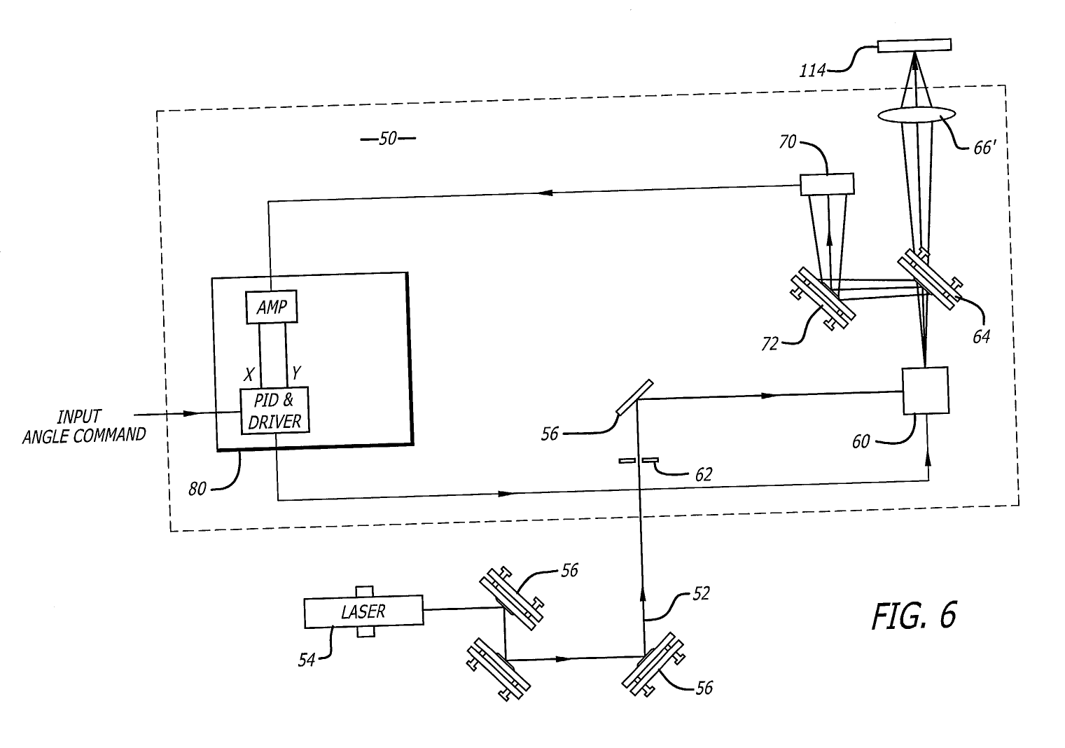

FIG. 6 shows yet another embodiment where a scan lens 66′ focuses the light beam to a point on a work piece 114. Focusing the beam to a point eliminates the need for the beam centering device and accompanying feedback system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, although the beam centering device 58 and beam scanning device 60 are shown in the same scanner module 50, it is to be understood that the devices 58 and 60 may be mounted to different mechanical platforms.

What is claimed is:

1. An optical scanner that can scan a light beam, comprising:
a beam scanning device;
a beam centering device that positions the light beam onto said beam scanning device;
a first position feedback system coupled to said beam scanning device; and,
a second position feedback system coupled to said beam centering device.

2. The scanner of claim 1, wherein said beam scanning device includes a pivoting mirror.

3. The scanner of claim 1, wherein said beam centering device includes a pivoting mirror.

4. The scanner of claim 1, wherein said beam centering device includes a pivoting plate.

5. The scanner of claim 1, wherein said beam centering device includes a voice coil motor.

6. The scanner of claim 1, wherein said first position feedback system includes a lateral effect detector.

7. The scanner of claim 1, wherein said second position feedback system includes a quad cell detector.

8. The scanner of claim 1, further comprising an input aperture and a scanning lens.

9. An optical scanner that can scan a light beam, comprising:
beam scanning means for scanning the light beam;
beam centering means for positioning the light beam onto said beam scanning means;
first position feedback means for controlling said beam scanning means; and,
second position feedback means for controlling said beam centering means.

10. The scanner of claim 9, wherein said beam scanning means includes a pivoting mirror.

11. The scanner of claim 9, wherein said beam centering means includes a pivoting mirror.

12. The scanner of claim 9, wherein said beam centering means includes a pivoting plate.

13. The scanner of claim 9, wherein said beam centering means includes a voice coil motor.

14. The scanner of claim 9, wherein said first position feedback means includes a lateral effect detector.

15. The scanner of claim 9, wherein said second position feedback means includes a quad cell detector.

16. The scanner of claim 9, further comprising an input aperture and a scanning lens.

17. A method for scanning a light beam, comprising:
directing a light beam onto a beam scanning device with a beam centering device;
moving the light beam with the beam scanning device;
sensing the position of the light beam; and,
actuating the beam centering device to redirect the light beam if the sensed position deviates from a desired position.

18. The method of claim 17, wherein the light beam is moved along a scanning line by the beam scanning device.

19. An optical scanner that can scan a light beam onto a workpiece, comprising:
a beam scanning device;
a lens that focuses the light beam onto a point of the work piece; and,
a position feedback system coupled to said beam scanning device.

20. The scanner of claim 19, wherein said beam scanning device includes a pivoting mirror.

21. The scanner of claim 19, wherein said beam scanning device includes a pivoting plate.

22. The scanner of claim 19, wherein said beam scanning device includes a voice coil motor.

23. The scanner of claim 19, wherein said position feedback system includes a lateral effect detector.

24. An optical scanner that can scan a light beam onto a workpiece, comprising:
beam scanning means for scanning the light beam;
position feedback means for controlling said beam scanning means; and,
lens means for focusing the light beam onto a point of the workpiece.

25. The scanner of claim 24, wherein said beam scanning means includes a pivoting mirror.

26. The scanner of claim 24, wherein said position feedback means includes a lateral effect detector.

27. A method for scanning a light beam onto a workpiece, comprising:
moving the light beam with a beam scanning device;
focusing the light beam onto a point of the workpiece;
sensing the position of the light beam; and,
actuating the beam scanning device to redirect the light beam if the sensed position deviates from a desired position.

28. The method of claim 27, wherein the light beam is moved along a scanning line by the beam scanning device.
